(19) United States
(12) Patent Application Publication
(10) Pub. No.: US 2012/0058290 A1
(43) Pub. Date: Mar. 8, 2012

(54) Pre-leveled mosaic sheet and the process for making the same

(76) Inventor: Guohua Song, Antich, CA (US)

(21) Appl. No.: 12/807,418

(22) Filed: Sep. 4, 2010

(51) Int. Cl. B44C 1/28; B44F 11/04; E04F 13/00; B32B 3/14; B44C 1/26

(52) U.S. Cl. 428/42.2; 428/49; 156/71

(57) ABSTRACT

A pre-leveled, integrated mosaic sheet consists of a flat, rigid supporting board having an array of uniformly spaced small holes for coupling tesserae to a target wall, wherein the tesserae are pre-patterned and attached to the supporting board's front surface, each of which covering at least one of the small holes.

### FIELD OF THE INVENTION

The present invention generally relates to construction materials, and more particularly to an integrated pre-leveled mosaic sheet and a process for making the same.

### BACKGROUND OF THE INVENTION

Mosaic is the art of creating images with an assemblage of small pieces of colored glass, stone, or other materials. It may be a technique of decorative art, an aspect of interior decoration, or of cultural and spiritual significance as in a cathedral. Small pieces known as tesserae are used to create a pattern or picture. A tessera (plural: tesserae, diminutive tessella) is an individual tile in a mosaic, usually formed in the shape of a cube and made of stone or glass of different colors. It is also known as an abaciscus or abaculus. In antiquity, mosaics were formed from naturally colored pebbles, but by 200 BC purpose-made tesserae were being used. Marble or limestone was cut into small cubes that were arranged into the design. Later, tesserae were made from colored glass, or clear glass backed with metal foils. The Byzantines used tesserae with gold leaf, in which case the glass pieces were flatter, with two glass pieces sandwiching the gold. This produced a golden reflection emanating from in between the tesserae as well as their front, causing a far richer and more luminous effect than even plain gold leaf would create.

Currently there are various mosaic sheets available in the market. In a typical mosaic sheet according to the existing arts, as illustrated in FIG. 1A and FIG. 1B, an array (7×8) of tesserae 13 is attached to a piece of thick paper 11 through a web or mesh of adhesive 12. In an installation of mosaics, the worker peels off the paper 11 from the tesserae 13 and then attaches the tesserae to the target wall piece by piece. In most circumstances, both the paper 11 and the web of the adhesive 12 are peeled off before the tesserae are installed onto the wall. Due to the small size of the tessera piece, it is very difficult to level a large number of pieces on the wall. Although the small pierces of the tesserae 13 can be still connected by the web or mesh of adhesive 12, due to the flexibility of the web or mesh of adhesive 12, it requires skills and experience to level the small pieces of tesserae 13 in installation. If the small pieces are not uniformly well-leveled on the wall, the mosaics installed would look ugly.

What is desired is an integrated pre-leveled mosaic sheet that enables an ordinary person with little or no experience to install mosaics effectively and efficiently.

### SUMMARY OF THE INVENTION

The first preferred embodiment of the present invention is a pre-leveled, integrated mosaic sheet, which consists of a rigid flat supporting board with a square shape and an even thickness and an array of uniformly spaced tesserae fixed to the board's front surface using a first binding substance. The board has an array of uniformly spaced small holes perpendicular to the board. Each of the tesserae covers at least one of the small holes such that when, in installation, the board's back surface is fixed to a wall using a second binding substance, the second binding substance binds the tesserae to the wall through the small holes. The small holes can be round and any other shape. The board can be made of concrete or other materials with required rigidity, such as a plastic sheet bonded to an aluminum sheet. The board's thickness is approximately 1-5 mm. The first binding substance can be an adhesive fit for binding the tessera to the front surface of the board. The second binding substance is typically concrete.

In the second preferred embodiment, a supporting board for pre-leveled mosaic installation is introduced. The supporting board includes a rigid flat member with a square shape and an even thickness, the flat member having an array of uniformly spaced small round holes perpendicular to the flat member. A coating of binding substance evenly is coated on the flat member's front surface, the binding substance being fit to bind a tessera to the flat member. A peelable non-sticky paper is then covered to the binding substance. The flat member is typically made of concrete. Optionally, it can be a double-layer aluminum-plastic board. The board's thickness is approximately 1-5 mm. In the installation, a worker first peels the non-sticky papers off from the supporting boards and fixes the tesserae to the supporting boards according to the intended tessera pattern. Then, the worker applies an adhesive, such as wet concrete, onto the wall, and installs various supporting boards to the wall.

The third preferred embodiment is a process for making an integrated mosaic sheet convenient for mosaic installation. The process includes the steps of:

(a) providing a rigid flat board with a square shape and an even thickness;
(b) punching an array of uniformly spaced small round holes perpendicular to the flat board;
(c) applying a binding substance such as an adhesive to the board's front surface;
(d) fixing an array of uniformly spaced tesserae to the board's front surface, each of the tesserae covering at least one of the small holes such that when the board's back surface is fixed to a wall using a second binding substance which binds the tesserae to the wall through the small holes.

The advantages of the present invention are numerous. For examples, first, the installation of the pre-leveled mosaic sheet requires minimal experience, skills or training. Second, it increases the efficiency of the installation at least ten times over the prior art, and thus decreases the overall construction costs. Third, it maximizes the uniformity and quality of the installation project.

### BRIEF DESCRIPTION OF THE FIGURES

FIG. 1A is a schematic diagram illustrating a typical mosaic sheet according to the prior art;

FIG. 1B is a schematic diagram illustrating how a mosaic sheet is made according to the prior art;

FIG. 2A is a schematic diagram illustrating a front view of the pre-leveled, integrated mosaic sheet according to the first preferred embodiment of the present invention;

FIG. 2B is a schematic diagram illustrating a sectional view of the pre-leveled, integrated mosaic sheet according to the first preferred embodiment;

FIG. 2C is a schematic diagram illustrating a side view of the mosaic sheet of FIG. 2A;

FIG. 2D is a schematic diagram illustrating how various mosaic sheets according to the first preferred embodiment are installed on a target wall;

FIG. 2E is a schematic side view diagram illustrating the coupling of the mosaic sheet to the target wall through a binding substance, wherein each tessara piece is also coupled to the wall through the binding substance entered into the small holes on the mosaic sheet;

FIG. 3A is a schematic diagram illustrating a front view of a pre-leveled supporting board for mosaic installation according to the second preferred embodiment;

FIG. 3B is a schematic diagram illustrating a side view of the supporting board according to FIG. 3A;

FIG. 3C is a schematic diagram illustrating the tesserae being fixed to the pre-leveled supporting board for mosaic installation according to the second preferred embodiment;

FIG. 4A is a block diagram illustrating a process according to the third preferred embodiment;

FIG. 4B is a block diagram illustrating a process of FIG. 4A with a first optional step; and

FIG. 4C is a block diagram illustrating a process of FIG. 4A with a second optional step.

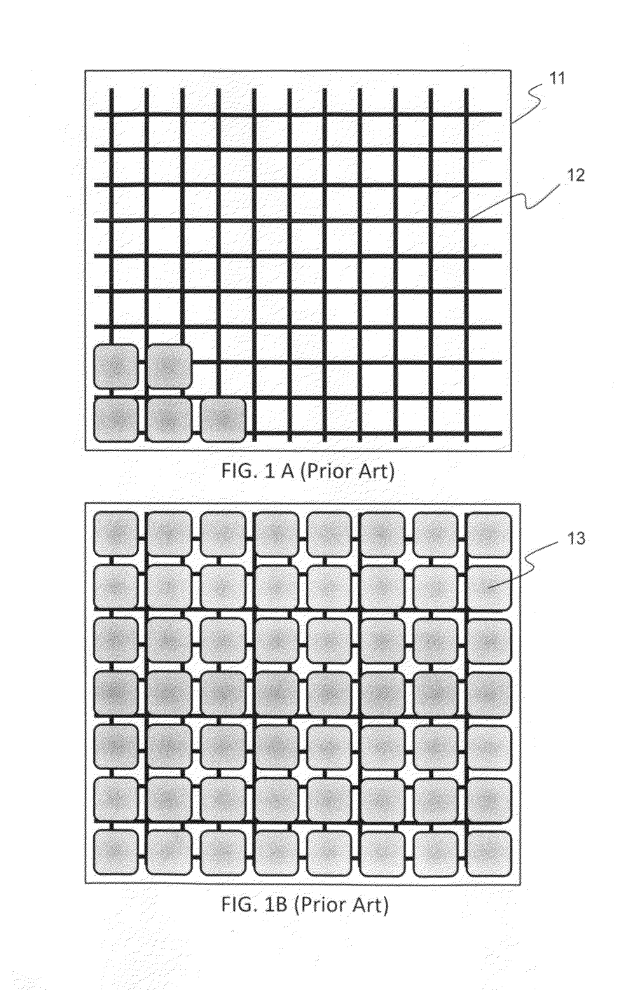

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation or restriction of the scope of the invention is thereby intended. Any alterations and further implementations of the principles of the invention as described herein are contemplated as would normally occur to one skilled in the art to which the invention relates.

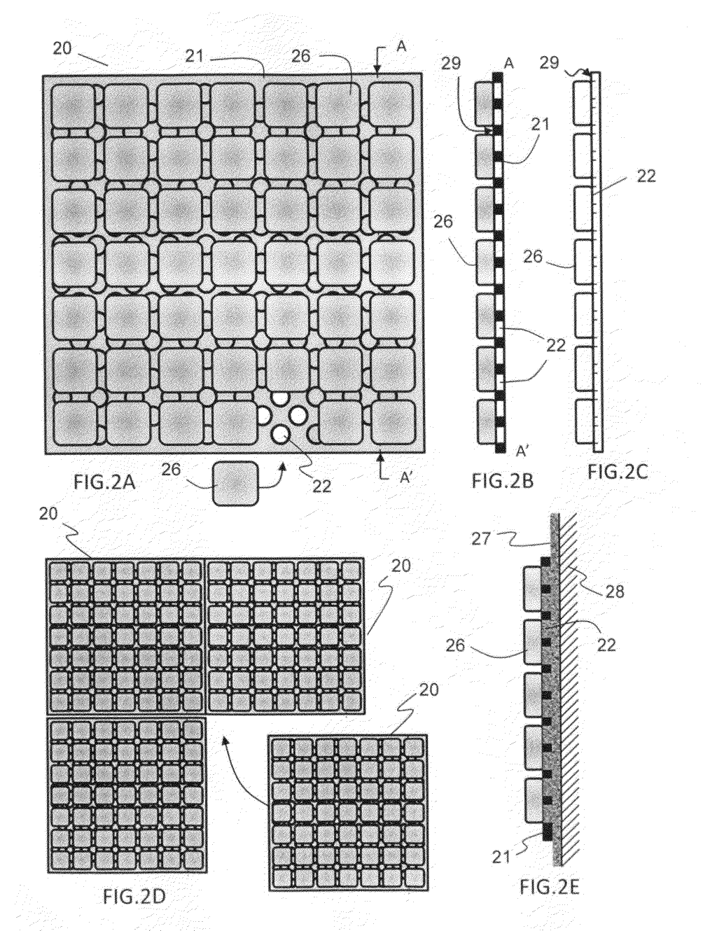

FIG. 2A is a schematic diagram illustrating a front view of the pre-leveled, integrated mosaic sheet 20 according to a first preferred embodiment. FIG. 2B is a schematic diagram illustrating an A-A′ sectional view of the pre-leveled, integrated mosaic sheet of FIG. 2A. FIG. 2C is a schematic diagram illustrating a side view of the mosaic sheet of FIG. 2A. The pre-leveled, integrated mosaic sheet 20 consists of a rigid flat supporting board 21 with a square shape or a cubic shape and an even thickness, typically 1-10 mm depending on the materials used for the board 21. There is an array of uniformly spaced tesserae 26 fixed to the board's front surface 29 using a first binding substance appropriate for binding the tesserae to the board 21. The first binding substance is not shown on FIGS. 2A-2C. The board 21 has an array of uniformly spaced small holes 22 perpendicular to the board 21. Each of the tesserae 26 covers at least one of the small holes 22 such that when, in installation as shown in FIG. 2D and FIG. 2E, the board's back surface is fixed to a target wall 28 using a second binding substance 27, the second binding substance 27 binds the tesserae 26 to the wall 28 through the small holes 22. The small holes 22 can be round or any other shape. Preferably, the holes' shapes and sizes are uniform. The board 21 can be made of concrete or other materials with required rigidity, such as a plastic sheet bonded to an aluminum sheet. In a situation where aluminum or other metal is used as a layer of the board, the board's overall thickness is approximately 1-5 mm. The first binding substance can be an adhesive appropriate for binding the tesserae 26 to the front surface 29 of the board 21. The second binding substance is typically concrete. The concrete is wet during the installation. Upon drying, the concrete tightly binds the tesserae 26 and the board 21 to the wall 28 as shown in FIG. 2E. In installation, a worker just applies the second binding substance to the wall and then attaches the mosaic sheets 20 to the wall piece by piece as shown in FIG. 2D.

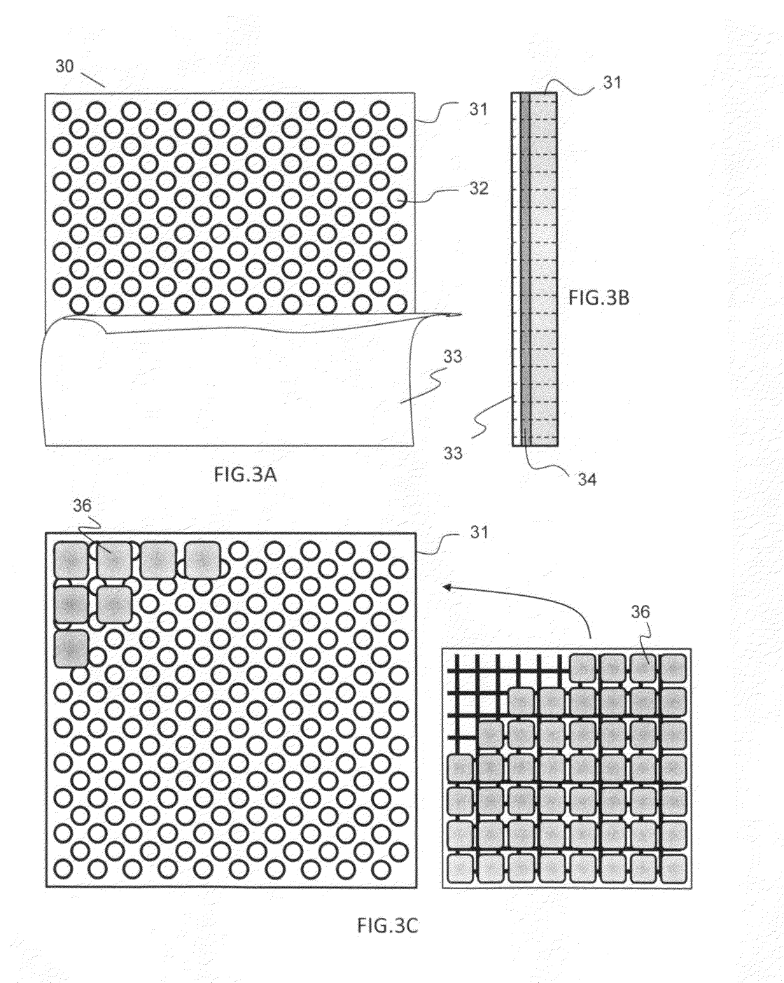

In a second preferred embodiment of the present invention, a supporting board for pre-leveled mosaic installation is introduced. FIG. 3A is a schematic diagram illustrating a front view of the pre-leveled supporting board 30 for mosaic installation according to the second preferred embodiment. FIG. 3B is a schematic diagram illustrating a side view of the supporting board. FIG. 3C is a schematic diagram illustrating the tesserae 36 being fixed to the pre-leveled supporting board for mosaic installation. As shown in FIG. 3A, the supporting board 30 includes a rigid flat member 31 with a square shape and an even thickness. The flat member 31 includes an array of uniformly spaced small holes 32 perpendicular to the flat member 31. A coating of binding substance 34, as shown in FIG. 3B, is evenly coated on the flat member's front surface. The binding substance 34 is appropriate to bind a tessera 36, as shown in FIG. 3C, to the flat member 31. A peelable non-sticky paper 33, as shown in FIG. 3A and FIG. 3B, is then covered to the binding substance 34. In manufacturing, the small holes 32 can be made before the binding substance 34 is applied to the board's front surface. Optionally, the small holes 32 can be made after the binding substance 34 is covered by the non-sticky paper 33. The flat member 31 is typically made of concrete. Optionally, it can be a double-layer aluminum-plastic board. If aluminum or other metal is used as a layer of the board, the board's thickness is approximately 1-5 mm. In the installation, a worker first peels the non-sticky paper 33 off from the supporting board 31 and fixes the tesserae 36 to the supporting board 31 according to the intended mosaic pattern. Then, the worker applies an adhesive, such as wet concrete, onto the target wall, and then installs various supporting boards to the wall as illustrated in FIG. 2D. The wet concrete touches the tesserae through the small holes on the supporting board. Upon drying, the concrete binds the tesserae 36 and the board 31 tightly to the wall.

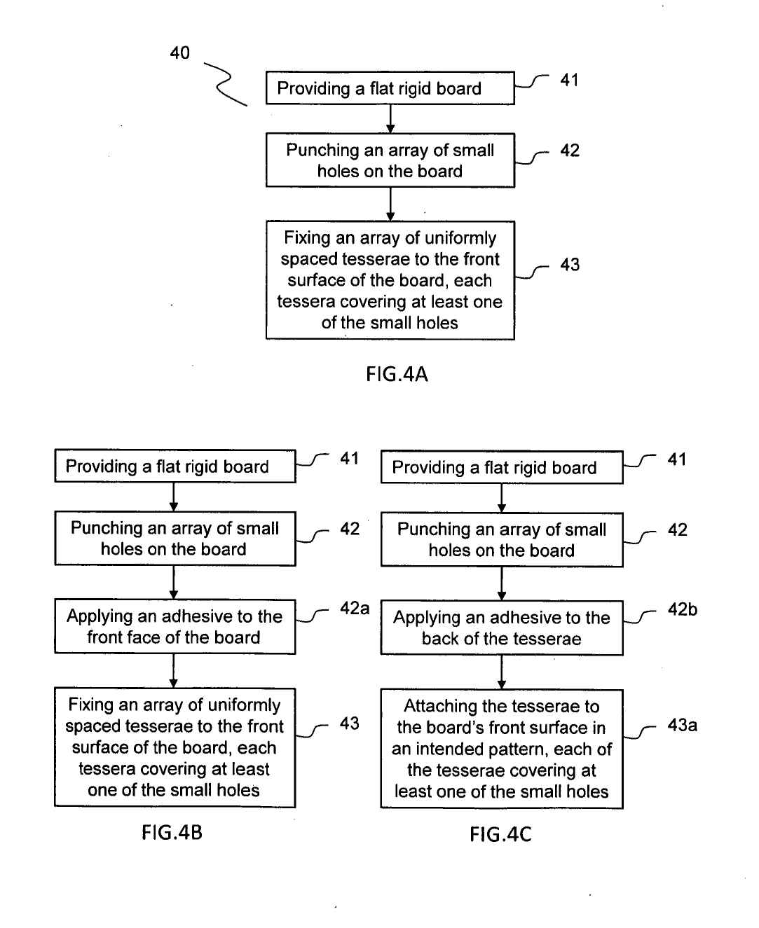

FIG. 4A is a block diagram illustrating a process 40 for making an integrated mosaic sheet convenient for mosaic installation. The process includes the steps of:

Step 41: providing a rigid flat board with a square shape and an even thickness;

Step 42: punching an array of uniformly spaced small round holes perpendicular to the flat board; and

Step 43: fixing an array of uniformly spaced tesserae to the board's front surface using a binding substance, each of the tesserae covering at least one of the small holes such that when the board's back surface is fixed to a wall using a second binding substance which binds the tesserae to the wall through the small holes.

FIG. 4B is a block diagram illustrating a process of FIG. 4A with a first optional step:

Step 41: providing a rigid flat board with a square shape and an even thickness;

Step 42: punching an array of uniformly spaced small round holes perpendicular to the flat board;

Step 42a: applying a binding substance, such as a suitable adhesive, to the front face of the flat board;

Step 43: fixing an array of uniformly spaced tesserae to the board's front surface using a binding substance, each of the tesserae covering at least one of the small holes such that when the board's back surface is fixed to a wall using a second binding substance which binds the tesserae to the wall through the small holes.

FIG. 4C is a block diagram illustrating a process of FIG. 4A with a second optional step:

Step 41: providing a rigid flat board with a square shape and an even thickness;

Step 42: punching an array of uniformly spaced small round holes perpendicular to the flat board;

Step 42b: applying a binding substance, such as a suitable adhesive, to the back of tesserae;

Step 43a: attaching the tesserae to the board's front surface in an intended pattern, each of the tesserae covering at least one of the small holes such that when the board's back surface is fixed to a wall using a second binding substance which binds the tesserae to the wall through the small holes.

While one or more embodiments of the present invention have been illustrated above, the skilled artisan will appreciate that modifications and adoptions to those embodiments may be made without departing from the scope and spirit of the present invention.

1. A pre-leveled, integrated mosaic sheet, consisting of:
a rigid flat supporting board with a square shape and an even thickness, said board having an array of uniformly spaced small round holes perpendicular to said board; and
an array of uniformly spaced tesserae fixed to said board's front surface using a first binding substance, each of said tesserae covering at least one of said small holes such that when said board's back surface is fixed to a wall using a second binding substance, said second binding substance binds said tesserae to said wall through said small holes.

2. The pre-leveled, integrated mosaic sheet of claim 1, wherein said board consists of a plastic layer bonded to an aluminum layer.

3. The pre-leveled, integrated mosaic sheet of claim 3, wherein said board's thickness is approximately 1-5 mm.

4. The pre-leveled, integrated mosaic sheet of claim 1, wherein said second binding substance is concrete.

5. The pre-leveled, integrated mosaic sheet of claim 1, wherein said board is made of concrete.

6. A supporting board for pre-leveled mosaic installation, consisting of:
a rigid flat member with a square shape and an even thickness, said flat member having an array of uniformly spaced small round holes perpendicular to said flat member;
a coating of binding substance evenly coated on said flat member's front surface, said binding substance being fit to bind a tessera to said flat member; and
a peelable non-sticky paper covering said binding substance.

7. The supporting board of claim 6, wherein said flat board consists of a plastic layer bonded to an aluminum layer.

8. The supporting board of claim 7, wherein said board's thickness is approximately 1-5 mm.

9. The supporting board of claim 6, wherein said flat member is made of concrete.

10. A process for making an integrated mosaic sheet convenient for mosaic installation, comprising the steps of:
(a) providing a rigid flat board with a square shape and an even thickness;
(b) punching an array of uniformly spaced small round holes perpendicular to said flat board;
(c) fixing an array of uniformly spaced tesserae to said board's front surface using a binding substance, each of said tesserae covering at least one of said small holes such that when said board's back surface is fixed to a wall using a second binding substance, said second binding substance binds said tesserae to said wall through said small holes.

11. The process of claim 10, wherein step (a) further comprises the steps of:
providing an aluminum sheet; and
bonding a plastic sheet to said aluminum sheet.

12. The process of claim 10, wherein said board's thickness is approximately 1-5 mm.

13. The process of claim 10, wherein said rigid flat board is made of concrete.

14. The process of claim 10, further comprises the step of:
applying the binding substance to said board's front surface.

15. The process of claim 10, further comprises the step of:
applying the binding substance to a back surface of each of said tesserae.
